(19) United States
(12) Patent Application Publication
(10) Pub. No.: US 2015/0151682 A1
(43) Pub. Date: Jun. 4, 2015

(54) ELECTRONIC SYSTEM INSTALLED IN A MOTOR VEHICLE AND METHOD OF PROCESSING DATA FOR A MOTOR VEHICLE

(71) Applicant: Continental Automotive Systems, Inc., Auburn Hills, MI (US)

(72) Inventor: Iaran Gadotti, Guarulhos (BR)

(21) Appl. No.: 14/554,245

(22) Filed: Nov. 26, 2014

(30) Foreign Application Priority Data
Dec. 3, 2013 (BR) 102013031053-0

(51) Int. Cl. B60R 1/00

(52) U.S. Cl. CPC B60R 1/00

(57) ABSTRACT

An electronic system for analysis of driving/maintaining of a motor vehicle by its present or prior owner(s). The electronic system receives information from electronic sensors dispersed throughout a vehicle and computes the information obtained, revealing as the end result a grade of quality in driving/maintaining the car by its present/prior owners. The grade—a visual signal—is displayed on a dial and its purpose is to determine how much stress and wear the vehicle being analyzed has undergone when in the hands of its present/prior owners. This information in turn serves the interests of potential buyers of the vehicle who, assisted by the visual signal, can determine the real value of an automobile based on the actual wear and tear sustained by the vehicle.

### CROSS-REFERENCE TO RELATED APPLICATIONS

This application claims the benefit of Brazilian Patent Application No. 102013031053-0, filed Dec. 3, 2013. The disclosure of the above application is incorporated herein by reference.

### FIELD OF THE INVENTION

The present invention relates to an electronic system and a method of data processing for analysis and classification of the driving/maintenance profile of a given motor vehicle, such as an automobile, a motorcycle, a light, medium and heavy commercial vehicle, a bus or any other vehicle.

### BACKGROUND OF THE INVENTION

Vehicle display assemblies typically display information on one or more display surfaces to the occupants of passenger and commercial vehicles. One such vehicle display is an instrument cluster having a fuel gauge and/or other instrumentation to display important information and values to the vehicle occupants such as weather conditions, time, oil levels. Conventional instrument cluster assemblies typically include a housing and a display surface. One or more light sources are typically mounted to illuminate the display surface within the housing for viewing by the vehicle occupants.

Today, when a buyer wishes to purchase a used motor vehicle, there is some objective information available. Specifically, in the case of passenger cars, light commercial vehicles and motorcycles, said information is the model of the vehicle, the year the vehicle was manufactured, important options and its displayed mileage. On the basis of these first four pieces of information, the buyer can consult specialized catalogues that determine the market value of the vehicle he or she wishes to purchase. A good example of a specialized catalogue in the automotive field is the Kelley Blue Book Value (e.g., Kelley Blue Book Used Car Guide: Consumer Edition October-December 2014. Ed. Kelley Blue Book Editorial Staff. Kelley Blue Book Co, Inc., Oct. 7, 2014), frequently used to assist purchases made in this country.

On the basis of the fourth objective piece of information, the vehicle's mileage, a buyer can get “some idea” of the wear and tear undergone by the vehicle during its use. Theoretically, a below-average mileage suggests a purchase value higher than that shown in the Kelley Blue Book Table(s); on the other hand, an above-average mileage, denoting a vehicle showing more signs of wear (more likely to have mechanical problems, for example), presupposes a purchase value lower than the value stipulated in said table.

However, the mileage shown on a vehicle's odometer merely gives an incomplete picture of how much wear the vehicle sustained during its use.

A vehicle that has been poorly-driven, poorly cared-for (without proper preventive maintenance, for example) and exposed to harmful environmental conditions (pollution, inadequate fuel, extreme temperatures, etc.) wears out more rapidly than a vehicle that has been carefully-driven, well-maintained and exposed to environmental conditions less likely to contribute to its deterioration.

In this regard, it is well known, for example, that police vehicles, ambulances and school buses, which undergo harsher driving conditions, are typically sold at prices below prices for vehicles of the same model, optional features, year and mileage, because in these more specific cases, the buyer is aware that the desired vehicle had undergone a much greater level of stress/miles traveled than that of the particular used vehicle for sale on the market.

In any event, when buying an ordinary used vehicle, the consumer does not have any objective parameter available indicating the quality of how the vehicle was driven when used.

When buying a second-hand vehicle today, the consumer has just tips from and confidence in the good faith of the seller as to the quality level of driving/maintaining a given vehicle.

Some examples of the prior art are aimed at examining the driving profile of some motorists, but without taking into account the wear they inflict on their respective vehicles.

U.S. Patent Application No. US 2012/0109418, for example, discloses a system of identifying a driving profile configured to serve the interests of employers, fleet managers, car insurance professionals, and the like.

This documenting system compiles data such as: proximity of the vehicle to external objects during transport of the vehicle; acceleration; deceleration; and fuel consumption, among others. On the basis of this information, the system determines whether a given motorist has been driving a vehicle responsibly or irresponsibly. This type of information can be useful for an employer, an insurance company or a lessor of a vehicle, but it is irrelevant for a potential car buyer. This is because the system disclosed in this prior art aims at calculating the car's risk of collision and not the degree of wear and tear imposed on the car by its driver.

U.S. Pat. No. 8,352,118 discloses objects and techniques similar to the objects of US 2012/0109418. In any case, U.S. Pat. No. 8,352,118 is more concerned with providing information to legal authorities, parents of adolescents who own vehicles and other interested parties with a view to determining whether the driver of a vehicle usually violates traffic laws or exposes his or her own life and the life of passengers to high risks.

U.S. Pat. No. 8,352,118 achieves its objectives by methods such as: synchronization of a GPS system; a database limiting the speed and the speedometer of the vehicle; a camera configured to capture the driver's behavior while shifting the vehicle; and an electronic system that connects the data gathered in order to record careless maneuvers, among other things.

Therefore, like U.S. Patent Application No. US 012/0109418, the technology shown in U.S. Pat. No. 8,352,118 is incapable of providing relevant information to a potential vehicle buyer.

To overcome these disadvantages, the present invention seeks to lay out a solution to the state of the art providing a method of identifying the stress level imposed on a vehicle by its prior owners due to faulty driving or car maintenance.

### SUMMARY OF THE INVENTION

An object of the present invention is to provide a simple and efficient system for supplying information to a potential buyer of a used motor vehicle, such as an automobile, a motorcycle, a light, medium or heavy commercial vehicle or a bus, as regards the stress level imposed on this vehicle by its prior owner(s).

The object of the present invention is also a simple and efficient method for analyzing the stress level imposed on a vehicle due to poor handling by its prior owner(s).

The objects of the present invention are achieved by an electronic system installed in a motor vehicle, which system incorporates a calculus algorithm, associated with one or more electronic sensors and at least one dial that is installed in the motor vehicle.

The calculus algorithm is incorporated with a control unit configured to receive input information from the electronic sensors, and is configured to process that information from the electronic sensors, obtaining an electronic signal that corresponds to the quality of driving/maintaining the motor vehicle, and to transmit that electronic signal to the dial. The dial, upon receiving the electronic signal, is configured to display a visual signal, included between a range of at least three qualitative values, namely, a regular value, a highest value and a lowest value for the quality of driving/maintaining the motor vehicle.

The objects of the present invention are also achieved by a method of processing data to display a final average pertaining to the quality of driving and maintaining the motor vehicle, which includes receiving input information from electronic sensors; processing the information obtained in the previous stage, generating an electronic signal as a result; and decoding the electronic signal, displaying a visual signal as a final result that corresponds to the quality of driving/maintaining the vehicle on a dial.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front elevation view of a first vehicle dial in a preferred configuration of the present invention, showing a visual signal indicating the quality level of driving/maintaining a motor vehicle;

FIG. 2 is a front elevation view of a second vehicle dial in another preferred configuration of the present invention, showing a visual signal indicating the quality level of driving/maintaining a motor vehicle;

FIG. 3 is a flowchart illustration the operation of the electronic system, in accordance with the present invention;

FIG. 4 is a front view of a vehicle panel containing a dial of the present invention in an alternative embodiment, in accordance with the present invention; and

FIG. 5 is a front elevation view of a vehicle dial in a second alternative embodiment, in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

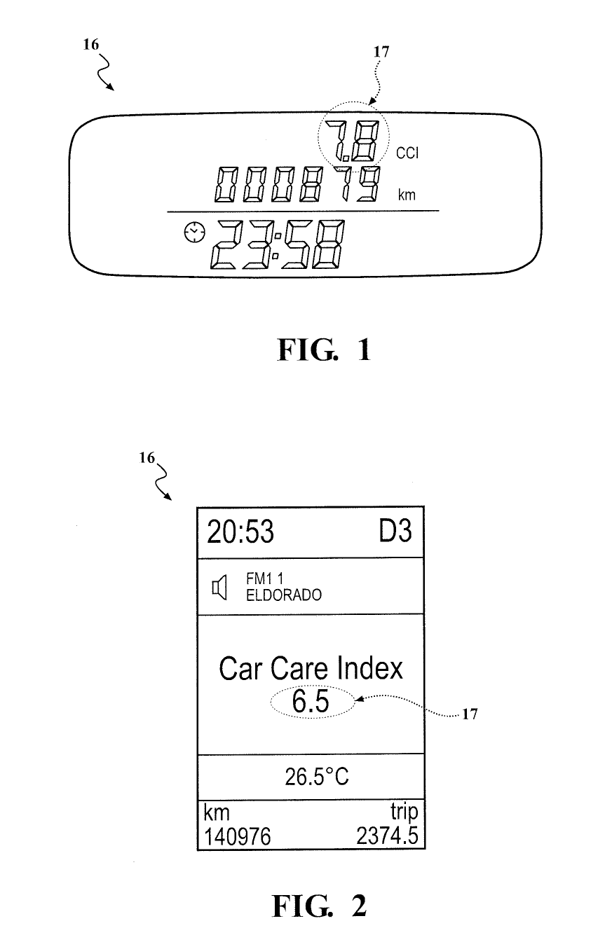

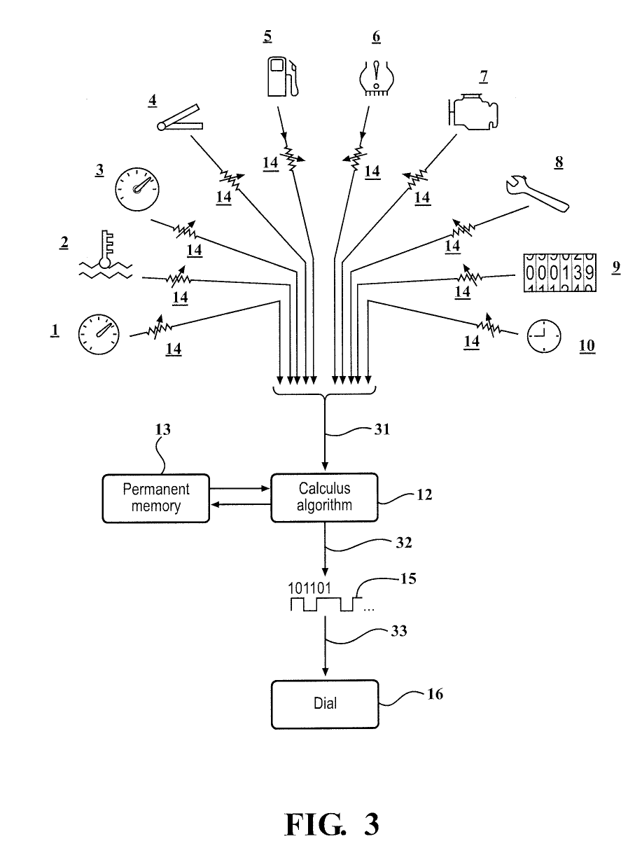

Referring to FIGS. 1-5 generally, the present invention includes an electronic system installed in a motor vehicle (such as an automobile, a motorcycle, a light, medium or heavy commercial vehicle, a bus, a tractor or agricultural machinery) that comprises a control unit 12 incorporating a predetermined calculus algorithm (see FIG. 3) and is operably coupled with a plurality of electronic sensors 14 and at least one dial 16.

The control unit 12 is an electronic control unit (ECU) such as provided by an instrument cluster of the motor vehicle, however, alternative ECUs are contemplated. At any time precise information about the vehicle condition is available on display. The ECU, e.g., instrument cluster, receives several parameters from the vehicle sensors and its algorithm processes the information to calculate a result or value, herein also referred to as a “Car Care Index” value. The Car Care Index (or “CCI”) is a value taken as the average resulting from the driving/care/maintenance of the vehicle over the vehicle lifetime. Most preferably, such a value is in the range of 1 to 10, which indicates the level of treatment the user(s) gave the particular vehicle, with 10 being the highest and best level of treatment. This is a significant advantage over an odometer value since the Car Care Index more comprehensively shows the level of treatment the car received during its lifetime. Conversely, odometer readings leave one to extrapolate, or more accurately stated-guess, from that single data point and visual assessments what quality of driving/care/maintenance the vehicle may or may not have received. It is also well known that visual assessments can fail, e.g., such as has been widely reported with fraudulent used vehicle sales of damaged vehicles that visually “looked okay” but that were in fact previously partially or fully submerged in flood waters unbeknown to the purchaser.

The CCI integrated in the ECU, e.g., instrument cluster, is much more precise, capable of accessing parameters not available externally to the instrument cluster, and is applicable with and follows the same standard for all brands, validation tests and overall quality, also making possible the correct comparison between different vehicles.

The instrument cluster is one of the main ECUs in a vehicle and is operably connected to the plurality of electronic sensors 14, and optionally, additionally to at least one other module, via hardwire connections, controller area network (CAN bus), Local Interconnect Network (LIN bus), and the like. The different parameters available in the vehicle are also operably available to the instrument cluster and its Car Care Index algorithm uses these parameters in the transformation of data to a value indicative of vehicle treatment over its lifetime. The CCI is storable, e.g., in permanent memory 13, in the instrument cluster memory and/or any other existing module connected to the vehicle network. Most preferably, the CCI is stored in multiple locations to avoid intentional and unauthorized manipulation or tampering with the information, which provides yet another significant benefit. In addition, past CCI values are stored. This has the additional significant advantage of generating additional information for consideration such as “snap shots” in time using these prior CCI values.

Some exemplary predetermined parameters or data used toward the CCI include, engine rotation, engine temperature, vehicle speed, vehicle acceleration, fuel consumption, usage of brakes, quantity of engine starts per day, regular maintenance done by the official dealer, odometer, time, and any other desired parameter.

The predetermined parameters must be normalized in order to become a standard value capable to run in all kinds of motor vehicles, e.g., buses, motorbikes, passenger cars and trucks, despite engine sizes/types, fuel types, and other variables between motor vehicles. There are several vehicle models/types in the market, with different engine sizes and configurations, and etc. In order to make the CCI value comparable between all the models/types, the parameters must be normalized; in other words, adjusted to the same scale.

The electronic sensors 14 fulfill the function of collecting data on operating, driving, maintaining a vehicle and the environment around it throughout its useful life being picked up at the dealer as a 0-mile vehicle.

By way of non-limiting example, the electronic sensors 14 are potentiometers, microswitch sensors, temperature sensors and fluid level sensors, among others. It is to be noted that in the figures, in order to facilitate showing the sensors 14, a symbol commonly adopted in representing a potentiometer was used; however, a potentiometer is not the only kind of electronic sensor that can be employed by the present invention. These electronic sensors 14 are positioned in strategic areas of the vehicle with a view to collecting data that together or individually indicate the manner of driving/maintaining the vehicle.

Preferably, but in a non-limiting manner, these sensors 14 are associated with a crankshaft rotation meter 1 (rotation sensor), a thermometer directly connected to the engine cooling fluid of the vehicle 2, a speedometer 3, an accelerator 4, a fuel gage 5, a brake activator 6, an engine starter 7, an electronic register for preventive maintenance at an authorized dealer 8, an odometer 9, and a digital clock 10.

Connecting the data obtained via sensors like these, the algorithm 12 can perceive inappropriate driving/maintenance activity, such as, among innumerable others: Elevated rotation of the crankshaft moments after starting the vehicle with the engine experiencing low temperatures; Stalling due to of low rotation; Overloading the engine with high rotation for prolonged periods of time; Accumulation of gasoline clogged in the fuel tank for a prolonged period of time; Failure to comply with preventive maintenance at authorized dealers; Intensified and abrupt use of the brakes; Simultaneously using the brake and accelerator; and, Overloading the engine at high temperatures.

By increasing some alternate electronic sensors 14, it is possible to identify other poor driving/maintenance activity that diminish the vehicle's useful life.

Examples of alternate electronic sensors 14 are: sensors for checking the viscosity of the crankcase lubricating oil; tire pressure; suspension activity; outdoor temperature; use of the clutch; and sensor for air pollution and fuel quality.

After collecting and sorting out the data obtained via the electronic sensors 14, the algorithm 12 sends an electronic signal 15 corresponding to the quality of driving/maintaining the vehicle to the abovementioned dial 16. The dial 16, which is operably installed in the vehicle, upon receiving the electronic signal 15, shows as output a visual signal 17 falling within a range of at least three qualitative values, namely: a regular value, a highest value and a lowest value of the quality of driving/maintaining the vehicle.

In a preferred configuration, the electronic system of this invention contains means to avoid corrupting the data by the vehicle owner. Thus, unlike with conventional odometers, the electronic system cannot be easily “reset” or “zeroized,” making it extremely difficult to corrupt the data obtained. The system also includes redundancies like a permanent memory 13 for storage for an indefinite time from the last update shown on the dial 16.

The electronic system of the present invention preferably includes a system for protection against fraud, which, similar to modern odometers, has a means for communicating with the central module of the vehicle. By this means of communication, the electronic system is constantly updating alterations of the grade appearing on the dial 16, storing a copy (backup) of this grade in the central module of the vehicle, and also rendering it more difficult to sabotage the grade given by the electronic system.

The preferred form of displaying the quality mark for driving/maintaining the vehicle is shown in FIGS. 1 and 2. In this preferred display, a number greater than or equal to 0.0 and less than or equal to 10.0 in Arabic numerals is shown as visual signals 17 (10.0 being the highest grade, that is, the grade of a new factory vehicle). This visual signal 17 is displayed on a dial 16 consisting of digital liquid crystal fabric which, in addition to the visual signal 17, also shows data such as local time, distance covered and the vehicle's mileage.

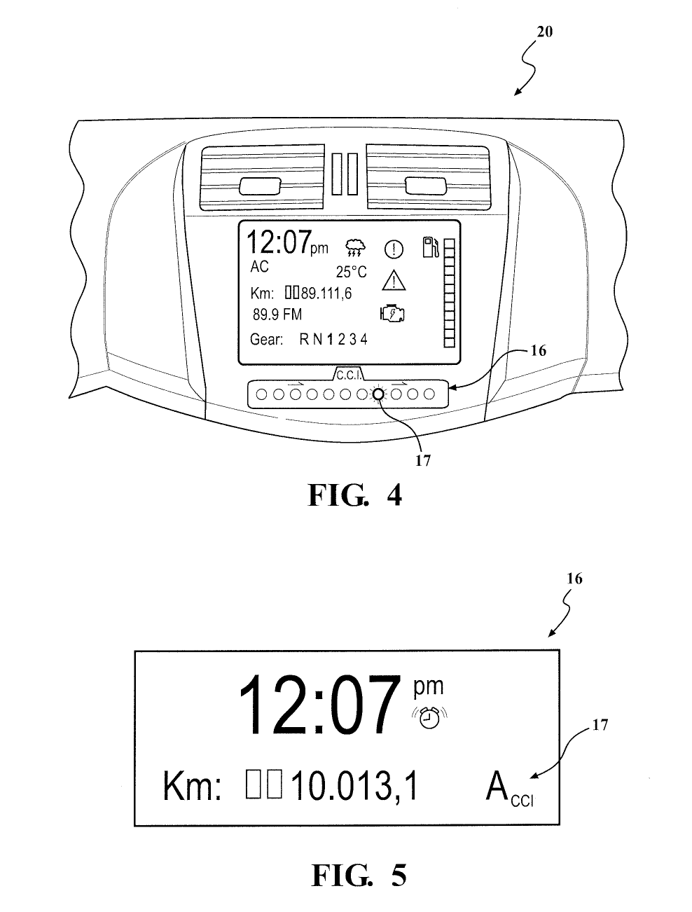

Other alternate forms (non-restrictive) for displaying the quality grade of driving/maintaining the vehicle are shown in FIGS. 4 and 5. FIG. 4 shows an electronic panel 20 equipped with a dial 16 that comprises a plurality of LEDs (light emission diodes) or the like, aligned in a horizontal arrangement; the LED more to the left of the dial corresponds to the worst quality grade of driving/maintaining the vehicle, and the opposite LED, on the right side of the dial 16, indicates the best quality mark of driving the vehicle. In this specific example, just one LED is lit when the ignition switch of the vehicle is activated. On this dial 16, the said lit LED corresponds to the visual signal 17.

Alternatively, the LEDs aligned horizontally in the configuration described above can be aligned vertically where the LED is placed lower in the row, indicating the driving/maintaining grade as low as possible in the vehicle being analyzed.

Another alternate form for displaying the grade of driving/maintaining the vehicle is the form shown on the dial 16 of FIG. 5. In this configuration, the visual signal 17 consists of the letter “A,” located on the right side of the mileage displayed on the dial 16. In this second alternate form for displaying the grade of quality/driving of the vehicle, the range of grades available run from the letter “A” (highest grade) to the letter “F” (lowest grade), running by letters “B,” “C,” “D” and “E.” Alternatively, the same range could comprise fewer or more letters, since the letter “A” indicates the best grade possible for the quality of driving/maintaining the vehicle, and all the letters in this range were sequenced according to the Roman alphabet.

It is to be noted that in FIGS. 1, 2, 4 and 5, the abbreviation “CCI” is shown on the dials 16. As set forth previously, the CCI is the abbreviation for Car Care Index. This abbreviation was created while developing the present invention to accompany the visual signal 17, thus establishing a recognizable pattern of an index for quality. In the preferred configuration of the present invention, upon finding the abbreviation CCI on a car dial, the well-informed buyer will know that the number accompanying that abbreviation immediately adjacent of these three initials refers to the quality grade for driving/maintaining the respective vehicle being analyzed.

The significance of the CCI would be particularly highly advantageous during the time to sell/buy a used car, to define maintenance periods, or to obtain insurance company discounts in insuring the vehicle. Additionally, it will naturally flow that the quantity of good and responsible drivers will increase, having impact on general traffic safety.

The methods of display shown in the figures and described herein are examples of embodiments of the present invention. From the teaching herein it is possible to conceive of innumerable embodiments of the present invention that are not true copies of the examples demonstrated here, but are still protected by the scope of the present invention.

In addition to the electronic system heretofore described, the present invention also shows, within its scope of protection, a method of data processing for motor vehicles, such method including the following steps: First stage 31: receiving input information from the electronic sensors 14; Second stage 32: processing the information obtained in the previous stage, generating an electronic signal 15 as a result; Third stage 33: decoding the electronic signal 15, displaying on a dial 16 a visual signal 17 as a final result, corresponding to the quality of driving/maintaining the vehicle.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An electronic system for a motor vehicle, comprising:
a control unit operably coupled to a plurality of electronic sensors which are operable to collect predetermined data of the motor vehicle and generate signals representative of the predetermined data, the control unit provided with a predetermined algorithm which controls generation of an electronic signal representing a value based on the predetermined data received from the plurality of electronic sensors, where the electronic signal is decodable to a visual signal;
at least one dial having at least one visual display, where the dial is operable to display the visual signal; and
at least one light source adjacent said visual display and operably positioned to selectively illuminate at least one area and/or surface of the visual display to exhibit the visual signal corresponding to quality of driving and/or maintaining of the motor vehicle.

2. The electronic system of claim 1, wherein the dial receives the electronic signal and upon receiving the electronic signal, shows as output the visual signal falling within a range of at least three qualitative values.

3. The electronic system of claim 2, wherein the at least three qualitative values comprise a regular value, a highest value, and a lowest value of the quality of driving/maintenance of the motor vehicle.

4. The electronic display system of claim 1, wherein the dial receives the electronic signal and upon receiving the electronic signal, shows as output the visual signal that is a single numerical value and additionally shows as output an additional visual signal within a range of at least three qualitative values.

5. The electronic display system of claim 1, wherein the dial receives the electronic signal and upon receiving the electronic signal, shows as output the visual signal that is a single numerical value and/or a single letter.

6. The electronic display system of claim 1, wherein the control unit is an electronic instrument cluster operably coupled to said plurality of sensors and, optionally, to at least one module using hardwire connections, CAN, BUS, and/or LIN BUS.

7. The electronic display system of claim 1, wherein the electronic system further includes a permanent electronic memory, such permanent electronic memory being configured to store for a predetermined period of time the most recent electronic signal sent to the dial.

8. The electronic display system of claim 1, wherein the electronic system further includes a permanent electronic memory, such permanent electronic memory being configured to store for an indefinite time the most recent electronic signal sent to the dial and all past values corresponding to previous quality of driving/maintenance of the motor vehicle.

9. The electronic system of claim 1, wherein the predetermined data is normalized such that the data is adjusted to the same predetermined scale in order that the value is comparable between vehicle models.

10. An electronic system installed in a motor vehicle, comprising:
a control unit provided with a calculus algorithm, the control unit operably coupled with one or more electronic sensors and at least one dial, said calculus algorithm operably configured to receive input information from the electronic sensors, process the input information from the electronic sensors, obtain an electronic signal that corresponds to the quality of driving/maintaining the motor vehicle, and transmit the electronic signal to the dial;
wherein the dial is operably configured to, upon receipt of the electronic signal, exhibit a visual signal, comprising a range of at least three qualitative values and/or a numerical value, reflecting a regular value, a highest value and a lowest value of the quality of driving/maintenance of the motor vehicle.

11. The electronic system of claim 10, wherein the dial is configured to display as a visual signal an Arabic numeral consisting of three digits, comprising one decimal digit and two digits to the left of the decimal point; the Arabic numeral runs from the values 0 to 10 “10.0” being the value indicating the highest quality of driving/maintenance of the vehicle and “0.00” the value corresponding to the lowest quality of driving/maintaining the vehicle.

12. The electronic system of claim 10, wherein the dial is configured to display as a visual signal an Arabic numeral consisting of two non-decimal digits, the Arabic numeral being between values 0 and 10, “10” being the value indicating the highest quality of driving/maintenance of the vehicle and “0” the value corresponding to the lowest quality of driving/maintaining the vehicle.

13. The electronic system of claim 10, wherein the dial is configured to display as visual signal a letter comprising limited sequential range of letters from the Roman alphabet, the letter “A” being the letter corresponding to the highest grade in evaluating the quality of driving/maintaining the vehicle, and the last letter in this range being the lowest grade in evaluating the quality of driving/maintaining the vehicle.

14. The electronic system of claim 10, wherein the dial further includes a plurality of light emitting diodes (LEDs) aligned in a horizontal arrangement, wherein the dial, when activated, shows just one lit LED, this lit LED comprising the visual signal corresponding to the quality of driving/maintaining the motor vehicle, such that the LED further from the side face of the vehicle represents the lowest grade in evaluating the quality of driving/maintaining said vehicle, and the LED at the opposite end represents the highest grade.

15. The electronic system of claim 10, wherein the dial includes a plurality of plurality of light emitting diodes (LEDs) aligned in a vertical arrangement, wherein the dial, when activated, shows just one lit LED, said lit LED comprising the visual signal corresponding to the quality of driving/maintaining the motor vehicle, such that the LED closer to the floor of the vehicle represents the lowest grade in evaluating the quality of driving/maintaining of said vehicle, and the LED at the opposite end represents the highest grade.

16. The electronic system of claim 10, wherein the electronic sensors are associated respectively with a crankshaft rotation meter, a thermometer directly connected to the engine cooling fluid of the vehicle, a speedometer, an accelerator, a fuel gage, a brake activator, an engine starter, an electronic register for preventive maintenance at an authorized dealer, an odometer and/or a digital clock.

17. The electronic system of claim 10, wherein the electronic system further includes a permanent electronic memory, such permanent electronic memory being configured to store for an indefinite time the most recent electronic signal sent to the dial.

18. The electronic system of claim 10, wherein the electronic system further includes a fraud protection system.

19. The electronic system of claim 18, wherein the fraud protection system includes a means of communication with the central module of the vehicle, said means of communication intended to frequently update the most recent electronic signal sent to the dial in the electronic memory of the central module of the vehicle.

20. A method of obtaining and displaying a final average of quality of driving and maintenance of a motor vehicle, comprising the steps of:
providing a control unit operably coupled to a plurality of electronic sensors which are operable to collect predetermined data of the motor vehicle and generate signals representative of the predetermined data, the control unit provided with a predetermined algorithm operable to control generation of an electronic signal based on the predetermined data received from the plurality of electronic sensors, where the electronic signal is decodable to a visual signal;
providing at least one dial operable to display the visual signal;
receiving input information from the electronic sensors in a first stage;
processing the information obtained in the first stage and generating the electronic signal as a result in a second stage; and
decoding the electronic signal and displaying as a final result on the dial the visual signal corresponding to the quality of driving/maintaining the vehicle in a third stage.
